(19) United States
(12) Patent Application Publication
(10) Pub. No.: US 2017/0106274 A1
(43) Pub. Date: Apr. 20, 2017

(54) JOYSTICK COVER

(71) Applicants: Brandon RAMCHERAN, Studio City, CA (US); Carlos MONTOYA, Los Angeles, CA (US)

(72) Inventors: Brandon RAMCHERAN, Studio City, CA (US); Carlos MONTOYA, Los Angeles, CA (US)

(21) Appl. No.: 15/296,062

(22) Filed: Oct. 18, 2016

Related U.S. Application Data
(60) Provisional application No. 62/243,836, filed on Oct. 20, 2015.

(51) Int. Cl. A63F 13/24

(52) U.S. Cl. CPC A63F 13/24; A63F 2300/1043

(57) ABSTRACT

A joystick cover configured to attach to a joystick of a video game controller is disclosed. The joystick cover has an elastomeric body for attaching to an analog joystick of a video game control, as well as a cover that is attached to the elastomeric body. The joystick covers may have a top surface made of the materials used in fabricating sporting equipment such as that to make footballs, soccer balls, and baseballs for example. The joystick covers are made of a plurality of components which are readily interchangeable and may be adapted to match the specific video game being played. The joystick covers may be customized to include a logo or display multiple colors to match a color scheme associated with a professional sports organization.

RELATED APPLICATION INFORMATION

The present application claims priority under 35 U.S.C. Section 119(e) to U.S. Provisional Patent Application Ser. No. 62/243,836 filed Oct. 20, 2015 entitled “JOYTOPS” the disclosure of which is incorporated herein by reference in its entirety.

### BACKGROUND OF THE INVENTION

1. Field of the Invention

The present invention relates in general to video game controllers, and more particularly, for detachable joystick covers for joysticks on video game controllers.

2. Description of the Related Art

Game controllers are input devices used to enable users to participate in virtual environments such as in video games. Many game controllers employ a joystick which can be tilted about a center axis by a user's thumb, and may be used to provide directional input to a video game such as by moving, selecting, or manipulating virtual objects in two or three dimensional video game environments.

Many commercially available game controllers have one or more joysticks that are fabricated with highly texturized silicone grips that surround central bodies of the joysticks. The central body of the joystick may be fabricated from a hard plastic such as ABS plastic, and may have sharp edges which are not suitable for direct contact by users.

Over use, the silicone grip of the joystick begins to wear, exposing the ABS plastic main body. As a result, users may get blisters and cuts from use of the joysticks when the silicone grips are damaged or removed. Unfortunately, this is a very common issue facing the true video garners. Users must then either purchase commercially available joystick covers which may be fabricated from the same silicon type material, or purchase a new, often expensive, game controller. Many commercially available joystick covers may be made of similar silicone material found on the original game controllers, which may offer only a temporary fix for this reoccurring problem.

According, there exists a need for improving joystick covers.

### SUMMARY OF THE INVENTION

In a first aspect, a cover attachment for a controller joystick is disclosed. The attachment comprises an elastomeric body having a top surface and a cavity formed for receiving a joystick controller, the cavity formed on the bottom surface opposite the top surface, and a disk-shaped cover having a top surface and a bottom surface, the bottom of the disk-shaped cover coupled to top surface of the elastomeric body.

In a first preferred embodiment, the top surface of the cover is texturized to replicate an item associated with an activity. The top surface of the cover preferably comprises an image or text. The cover attachment preferably further comprises an retainer body having an aperture, a top surface, sidewalls, and a bottom surface, the sidewalls having at least one tab emerging inward from the bottom surface of the retainer body, the retainer body formed for detachably receiving the cover and elastomeric body. The elastomeric body preferably further comprises a top surface, generally cylindrical sidewalls having at least one slot, and the slots of the elastomeric body are preferably formed to receive the tabs of the retainer body. The retainer ring preferably further comprises a raised shoulder emerging away from the top of the retainer ring.

The cover attachment preferably further comprises an intermediary second disk-shaped cover having a top surface and a bottom surface, the top surface of the second disk-shaped cover coupled to the bottom surface of the disk-shaped cover, the bottom surface of the second disk-shaped cover coupled to the elastomeric body. The elastomeric body preferably has a channel formed generally radially at the inner perimeter of the elastomeric body, the channel formed to receive and detachably secure the disk-shaped cover and the second disk-shaped cover. The second disk-shaped cover is preferably fabricated from ABS plastic. The cover attachment preferably further comprises an annular outer ring having a top surface, generally cylindrical outer ring sidewalls, the outer ring sidewalls formed to detachably couple with the elastomeric body securing the cover to the elastomeric body. The elastomeric body preferably further comprises a rounded protrusion emerging away from the top surface of the elastomeric body, the protrusion formed at the center of the elastomeric body. The generally disk-shaped cover preferably has a cover rounded protrusion emerging away from the top surface of the cover, the cover rounded protrusion formed at the center of the cover.

In a second aspect, a cover attachment for a controller joystick is disclosed. The cover attachment comprises an elastomeric body having a top surface, generally cylindrical sidewalls having at least one slot, and a cavity formed for receiving a controller joystick, the cavity formed opposite the top surface of the body, a disk-shaped cover having a top surface and a bottom surface, the bottom surface of the disk-shaped cover positioned against the top surface of the elastomeric body, and an annular retainer ring having a top surface, generally cylindrical sidewalls, and a bottom surface, the retainer ring sidewalls having at least one tab emerging inward from the cylindrical sidewalls of the retainer ring, the retainer ring formed for detachably receiving the cover and elastomeric body. The slots of the elastomeric body are formed to receive the tabs of the retainer ring.

In a second preferred embodiment, the disk-shaped cover is fabricated out of a material associated with an activity. The top surface of the disk-shaped cover is preferably texturized to replicate an item associated with an activity. The top surface of the cover preferably comprises an image or text. The retainer ring preferably further comprises a raised shoulder emerging away from the top of the retainer ring. The elastomeric body, the disk-shaped cover, and the retainer ring preferably each have a color, wherein the colors of each are selected to match a color scheme. The disk-shaped cover is preferably fabricated from ABS plastic.

In a third aspect, a cover attachment for a controller joystick is disclosed. The cover attachment comprises a joystick attachment body having a top surface, sidewalls, and a coupling mechanism for detachably securing a joystick controller, a cover having a top surface and a bottom surface, the bottom surface positioned against the top surface of the joystick attachment body, and a retainer body having a top surface, sidewalls, and a bottom surface, the sidewalls formed to detachably couple with the joystick attachment body.

In a third preferred embodiment, the top surface of the cover is texturized to replicate an item associated with an activity. The top surface of the cover preferably comprises an image or text.

The present invention has other objects and features of advantage which will be more readily apparent from the following description of the preferred embodiments of carrying out the invention, when taken in conjunction with the accompanying drawings.

### DESCRIPTION OF THE DRAWINGS

FIG. 1 is a top, perspective view of joystick covers attached to a game controller in one or more embodiments.

FIG. 2 is a side, perspective view of a joystick cover.

FIG. 3 is a side, perspective view of the bottom of the joystick cover.

FIG. 4 is an exploded view of the joystick cover in an embodiment.

FIG. 5 is a top, cross-sectional view of the joystick cover.

FIG. 6 is a side, cross-sectional view of the joystick cover.

FIG. 7 is a side view of a joystick cover in an embodiment.

FIGS. 8A-8D are top views of joystick covers coupled to various game controllers.

FIG. 9A is a top view of a joystick cover having a cover fabricated from the material used to manufacture footballs.

FIG. 9B is a top view of a joystick cover having a cover fabricated from the material used to manufacture footballs, where the joystick cover is attached to a joystick of a game controller.

FIG. 10A is a top view of a joystick cover having a cover fabricated from the material used to manufacture basketballs.

FIG. 10B is a top view of a joystick cover having a cover fabricated from the material used to manufacture basketballs, where the joystick cover is attached to a joystick of a game controller.

FIG. 11A is a top view of a joystick cover attached to a joystick of a game controller in an embodiment.

FIG. 11B is a side view of a joystick cover in an embodiment.

FIG. 12A is a top view of a joystick cover attached to a joystick of a game controller in an embodiment.

FIG. 12B is a side view of a joystick cover in an embodiment.

FIG. 13A is a top view of a joystick cover attached to a joystick of a game controller in an embodiment.

FIG. 13B is a side view of a joystick cover an embodiment.

FIG. 14A is a top, perspective view of a joystick cover in an embodiment.

FIG. 14B is an exploded view of the joystick cover.

FIG. 14C is a cross-sectional view of the assembled joystick cover attached to a joystick.

FIG. 15A is a side view of a joystick cover in an embodiment.

FIG. 15B is an exploded view of the joystick cover.

FIG. 15C is a cross-sectional view of the assembled joystick cover attached to a joystick.

FIG. 16A is a top view of a joystick cover in an embodiment.

FIG. 16B is an exploded view of the joystick cover.

FIG. 16C is a cross-sectional view of the assembled joystick cover attached to a joystick.

FIG. 17 is a top, perspective view of a joystick cover having an alternative shape in an embodiment.

FIG. 18 depicts top views of covers having images of brand logos and sport accessories.

### DETAILED DESCRIPTION OF THE PREFERRED EMBODIMENTS

Many commercially-available video game controllers employ one or more joysticks, where the joysticks are typically fabricated as silicone grips surrounding hard plastic, central bodies. After extended use, the silicone grips become damaged, which exposes the hard plastic central bodies to the users. Users are then faced with the prospect of either replacing the entire video game controller, or finding a joystick cover which may be placed over the joystick.

One or more embodiments of joystick covers described herein are configured for attaching to joysticks of video game controllers. These joystick covers offer several important benefits to the users. First, the joystick covers may be fabricated from sporting materials such as from the materials used to fabricate sporting balls such as footballs, basketballs, and baseballs in an embodiment. Not only does the use of sporting materials provide the user with a visual indication of a particular sport, the user also experiences the tactile feedback of touching the sporting materials. These features combine to elevate the user's perception of being physically present in a virtual world and create a greater sense of immersion into the video game. Second, embodiments of the joystick covers offer a high level of customization to the user, both in terms of appearance and structural attributes. With respect to the customization of appearance, embodiments of the joystick covers enable the user to assemble the covers with components having colors which may match the color scheme of a professional sports team or other organizations. The joystick covers may accommodate logos or brands. With respect to the structural attributes, the joystick covers may have differing shapes and sizes for different user requirements.

In one or more embodiments, a joystick cover is configured to attach to a joystick of a gaming controller, and may fit onto any gaming controller's joystick universally. The joystick covers incorporate real sporting materials to the existing joystick which prevents wear and tear of the joystick covers. The joystick cover may have a top surface made of the materials used to make footballs, soccer balls, and baseballs for example. Embodiments of the joystick covers have advantages that mirror the benefits of athletes who play sports. Many athletes who play sports utilize the grip of the textured ball, plus the use of gloves and cleats to give themselves a competitive advantage over their competition. Likewise, embodiments of the joystick covers offer similar advantages, adding real elements of sports games to video game controllers. The grip and feel of a basketball, football, or soccer ball, elevates the game play experience and improves grip. The curved top surface of the joystick cover mirrors that of a real ball.

Moreover, the joystick covers may be assembled without glue or adhesives, and are thus readily interchangeable. A baseball joystick cover can be used when playing a baseball video game, and then be re-assembled to form a basketball joystick cover when playing a basketball video game for example. Hence, the joystick covers contribute to the user's experience by allowing the user to feel and see the material used in the video game the user may be playing. Users are more immersed into the game with the texture of the sporting material reinforcing the user's experience interacting with the video game.

Furthermore, embodiments of the joystick covers may be customized to include logos or may have multiple colors to match a color scheme associated with a professional sports organization. Embodiments allow gamers to customize the joystick covers to any color or theme. Embodiments may be aimed to sports enthusiasts, giving them an opportunity to show team pride. The implementation of real sport materials and the color customization enhances game play while giving gamers a competitive advantage.

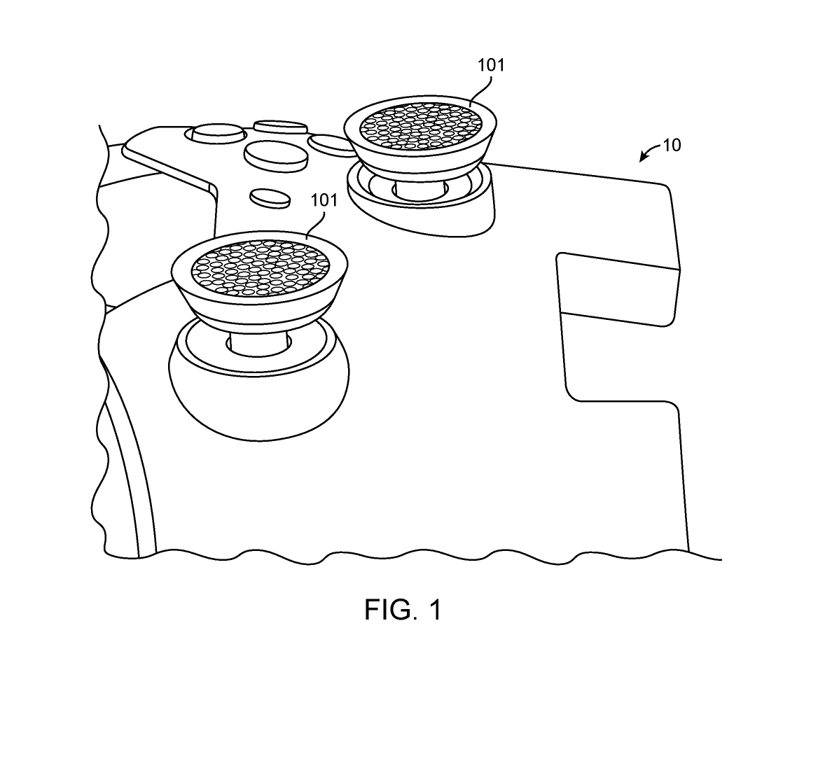

FIG. 1 is a top, perspective view of joystick covers 101 attached to a game controller 10 in one or more embodiments. The joystick covers 101 are joystick enhancements that attach directly to existing analog joysticks, and are aimed to elevate grip, gameplay, and longevity by utilizing real sporting materials. It provides gamers with a competitive advantage by delivering the grip of a football, basketball, and soccer ball directly onto the joystick itself. In turn, the use of sporting materials also prevents wear and tear by providing extra protection to the analog joystick.

Embodiments may solve many common issues facing gamers around the world. The use of the joystick covers prevents wear and tear to the existing controllers, which are typically expensive to replace. Also, the implementation of sporting materials to the joystick itself dramatically increases gamer experience while playing sport games. For example, for users playing a football game with a football grip joystick, the users “feel” the game. Embodiments are formed with the premium sporting materials which provide continued strength for many years.

Users may see improvements in gameplay. Some users may note the improved grip with the joystick covers. This improved grip was achieved by increasing the surface area. Also, many users may experience lessened joystick fatigue, allowing the gamer to play longer. The grip wall assisted players during intense sessions, preventing their thumbs from slipping off the joysticks. This was achieved by raising the side wall edges. Embodiments may provide a cost effective solution to a common problem, may prevent wear and tear to the joystick, and may prolong the life span of controller by many years. These features may save the users money.

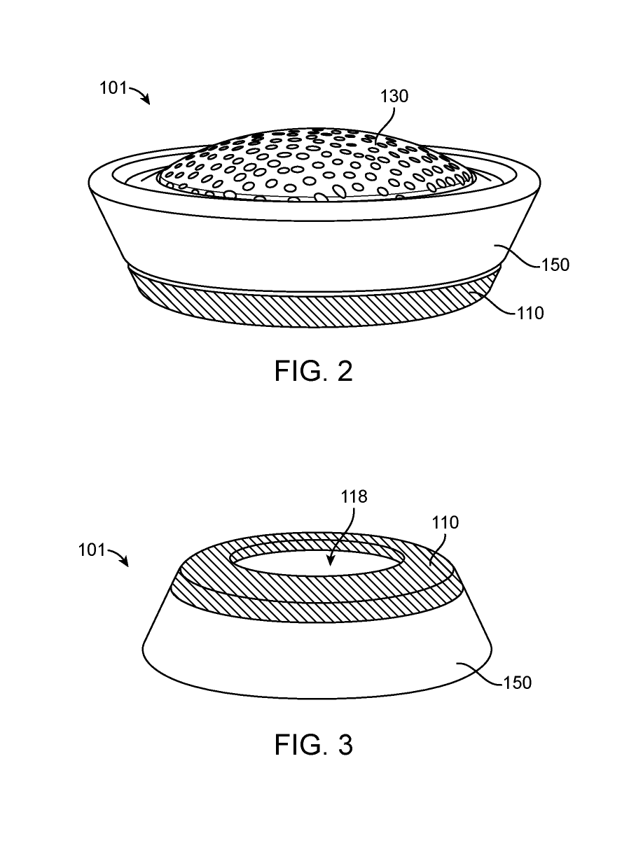

FIGS. 2 and 3 are a side, perspective view of a joystick cover 101, and a side, perspective view of the bottom of the joystick cover 101 respectively. In one or more embodiments, the joystick cover 101 comprises an elastomeric, molded, silicone joystick cap body 110 (i.e. an elastomeric body 110) configured for attaching to a joystick of a controller 10, a disk-shaped cover 130, and a retainer ring 150 (i.e., retainer body). The joystick cap body 110 may be formed out of elastomeric materials such silicone and natural or synthetic rubber which are sufficiently elastic such that the joystick cap body 110 return to its original shape after being temporarily deformed such as after being placed over a disk-shaped upper portion of a joystick. The retaining ring 150 may be formed out of stiffer materials such as injection molded ABS (acrylonitrile butadiene styrene) plastic, other plastics, or nylon for example.

The disk-shaped cover 130 may be fabricated out of the same material used for fabricating sporting accessories or balls such as textured vinyl fabric. For example, FIG. 2 depicts a cover 110 which is made out of the material used to fabricate basketballs, hence giving the cover 110 the distinctive orange color with a dimpled, textured surface. In one or more embodiments, the cover 130 may comprise other materials which have been colored and texturized to replicate the texture and color of sporting balls and accessories. The cover 130 may be made out the same material actually used in real-world activities, or may be made out of other materials colored and texturized to imitate real-world objects. Examples of types of covers 130 may include basketball material, baseball leather, baseballs having stitches, soccer ball material, and racing grips for automobile steering wheels for example.

Embodiments of the joystick covers 101 may be formed with components having different colors. For example, the joystick cap body 110 is depicted in FIGS. 2 and 3 by hash lines as having a different color than that of the retainer ring 150. Hence, the joystick covers 101 may have one, two, or three colors as the cover 130, the retainer ring 150, and the joystick cap body 110 may have different colors.

Embodiments solve the riddle of customization. Embodiments may have interchangeable inserts that can be made from any sporting material. The product can also have custom color arrangements with 3 unique color options, increasing the amount of options compared to joystick covers having only one solid color.

Embodiments of the joystick cover may provide consumers a premier alternative and contemporary design to support their favorite sport. Joystick covers described herein are made up of the actual grip from professional basketballs, footballs, and soccer balls allowing consumers to “feel” the game, which improves the gamer experience. This is an opportunity for gamers to further customize and show team pride of their favorite sport, simultaneously giving a competitive edge over their opponent. To further enhance the experience, embodiments of the joystick covers also provides options for team colors and logos implementation. Embodiments described herein may reflect principles users found in sports many have played growing up and applied them to the gaming world.

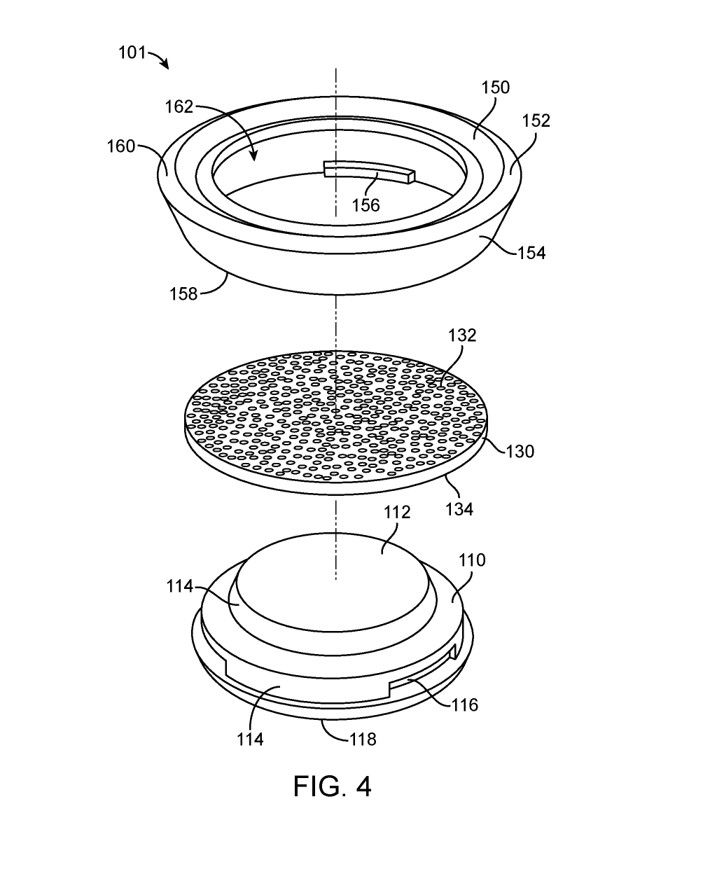

FIG. 4 is an exploded view of the joystick cover 101 in an embodiment. The joystick cover 101 (i.e., cover attachment 101) comprises an elastomeric, joystick cap body 110 (i.e., an elastomeric body 110) having a top surface 112, generally cylindrical sidewalls 114 having at least one slot 116, and a cavity 118 formed for receiving a controller joystick. The cavity 118 is formed opposite the top surface 112 of the body 110. The top surface 112 of the joystick cap body 110 may be shaped to have a contour including shaped to be concave, flat, or convex as shown. In one or more embodiments, the joystick cap body 110 has three slots 116.

The joystick cover attachment 101 further comprises a disk-shaped cover 130 having a top surface 132 and a bottom surface 134. The bottom surface 134 of the cover 130 is positioned against the top surface 112 of the joystick cap body 110. As shown in FIGS. 2 and 3, the cover 130 may be fabricated with a pliable material such that the cover 130 will deform to the shape of the top surface 112 of the joystick cap body 110. In one or more embodiments, the cover 130 is fabricated out of a material associated with an activity such as participating in a sport or driving an automobile for example. The top surface 132 of the cover 130 may be texturized to replicate an item associated with an activity such as sports or driving. In an embodiment, the top surface 132 of the cover 130 comprises an image or text.

The joystick cover attachment 101 also comprises an annular retainer ring 150 having a top surface 152, generally cylindrical sidewalls 154 which form an aperture 162, and a bottom surface 158. The sidewalls 154 have at least one tab 156 emerging inward from the cylindrical sidewalls 154 of the retainer ring 150. In one or more embodiments, the retainer ring has three tabs 156. The retainer ring 150 is formed for detachably receiving the cover 130 and the joystick cap body 110. The slots 116 of the joystick cap body 110 are formed to receive the tabs 156 of the retainer ring 150. In an embodiment, the retainer ring 150 further comprises a raised shoulder 160 emerging away from the top of the retainer ring 150. In an embodiment, the joystick cap body 110, the disk-shaped cover 130, and the retainer ring 150 each have a color, wherein the colors of each are selected to match a color scheme such as that for a professional sports team. The assembly of the joystick cover 101 relies on a unique locking mechanism of the slots 116 receiving and securing the tabs 156 and does not require the use of adhesives or glue.

In other words, embodiments described herein may be readily assembled without relying on adhesives or glue. Embodiments may have a unique locking mechanism securing the sport material 130 and retainer ring 150. Joystick covers 101 offer interchangeable inserts allowing for endless customization options. Embodiments may fit universally with most if not all controllers on the market today. Embodiments are assembled without the use of adhesives or glues, saving production costs and assembly time.

The 3 main components of the assembled product are the interchangeable flexible sport material 130, the ring 150 or (i.e., the grip wall), and the elastomeric silicone cap 110.

In step one of the assembly, the sport material 130 is inserted into the ring 150, securing itself within the ring 150. The flexible material sporting material 130 sits just inside the lip of the ring 150, fortifying itself together (i.e., the sporting material 130 and ring 150) without adhesives or glue. The nature of the sporting material 130 flex against the ring's 150 inner lip creates the bond. In step two of assembly, the sports material 130 and ring 150 assembly connects atop of the silicone cap 110. The sports material 130 and ring 150 assembly attaches to the top of the silicon cap 110 using grooves along the edge. The sports material 130 and ring 150 assembly unit has grooves or teeth that connect to the cap without any adhesives or glue. The flexibility of the silicon caps and the teeth grooves creates a complete unit, joystick cover 101. In step three of the assembly, the joystick cover connects to gamer's joystick. The silicone cap 110 has enough flexibility to attach itself universally to any joystick. Similar to a swimming cap, the silicone 110 fortifies itself without adhesion or glue. Embodiments have interchangeable sport material inserts and/or logos.

Other materials or designs are contemplated in one or more embodiments, For example, the sport material 130 could use other materials other than sporting materials such as high grip rubber or silicone. Embodiments may have flatten, concave or convex surfaces of the sport material 130. For the ring 150, embodiments may alter the diameter (increase or decrease) and thickness (round-off or sharpen the edges of hard plastic), and may use of different material such as high tack rubber/silicone, metal, cloth, leather. For the silicon cap 110, embodiments may change material used (higher or cheaper quality material). Embodiments may create single unit (no moving/interchangeable parts), generic joystick covers 101 that doesn't have ability to customize or incorporate real sports material (use generic silicone for complete product).

Without using glue, the locking mechanism was engineered to secure the flexible sport material 130 to the joystick. The ring 150 uses teeth to attach itself to the silicon cap 110, which are made with grooves fit for the teeth. The ring 150 fortifies itself to the silicon cap 110 while securing in place the sport material. There can be any number of teeth and grooves to create this bond without adhesives. The diameter of the interchangeable thumb grip 150 can be of any size to increase thumb grip performance and may be sized approximately in the range of 1 mm to 100 mm. The grip wall 150 can be any shape to maximize thumb grip performance for the gamer. The grip wall 150 can be pointed, squared, rounded, beveled, creased, jagged, sharp, soft, hard, wet, dry, and made of any material. The thickness and height of the grip wall 150 are also unlimited. Embodiments may have a range of thickness and height from an approximate minimum of 0.25 mm and an approximate maximum of 100 mm. Embodiments may incorporate real basketball, football, and soccer materials to the joystick of a gaming controller. Embodiments may have a unique locking mechanism, securing the interchangeable sport material between two other unique parts without using any adhesive or glue. Embodiments also provide the ability to customize color and theme to support your favorite sport teams.

FIG. 5 is a top, cross-sectional view of the assembled joystick cover 101. The retainer ring 150 receives the cover 130 and engages with the joystick cap body 110, pressing the cover 130 flush against the joystick cap cover 110 via the ledges 164 which protrude inward to cover the outer perimeter of the cover 130. The slots 116 of the joystick cap body 110 receive and mate with the tabs 156 of the retainer ring 150. The mating of tabs 156 and the slots 116 serves to secure the retainer ring 150 to the joystick cap body 110 as well as to prevent rotation of the retainer ring 150 relative to the joystick cap body 110 during game play.

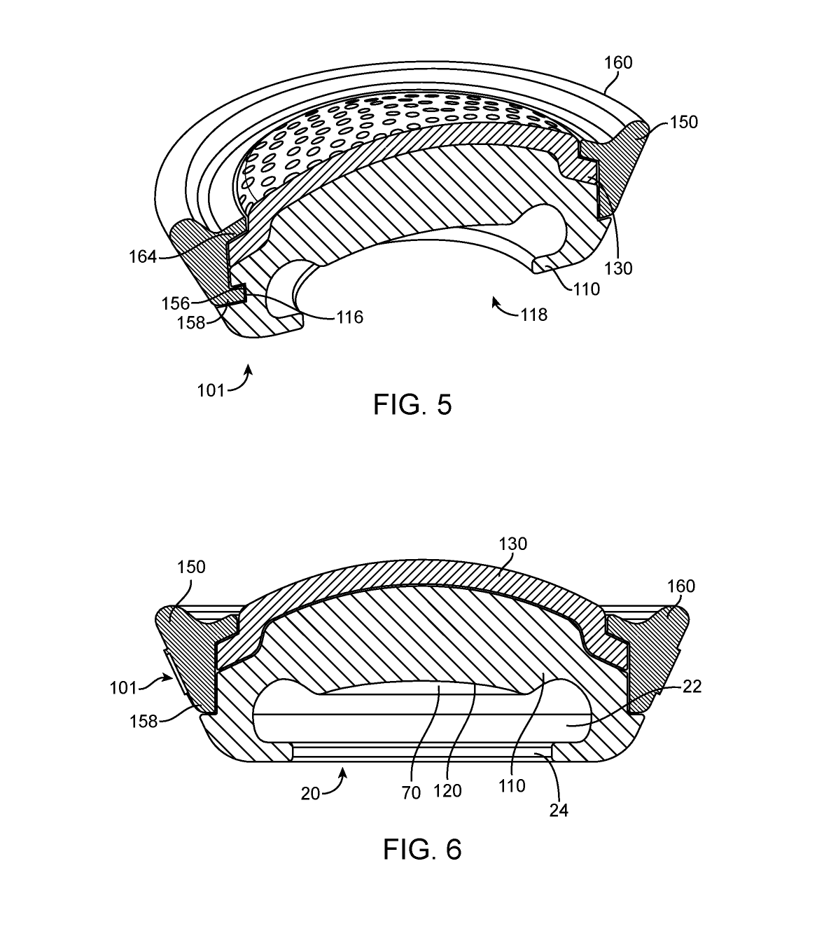

FIG. 6 is a side, cross-sectional view of the joystick cover 101 mounted on a joystick 20. A joystick 20 typically comprises a rod portion 24 which may be mechanically tilted by the user interacting with a video game, and a disk-shaped top portion 22 positioned at the top section of the rod portion 24. The cavity 118 of the elastomeric joystick cap body 110 receives the joystick 20 by flexing elastically during installation. Once the elastomeric joystick cap body 110 mates with the joystick 20, the elastomeric joystick cap body 110 returns to its original state. The user may place the cover 130 over the joystick cap body 110 and then complete assembly by engaging the retainer ring 150 with the joystick cap body 110. As shown, the bottom surface 158 extends downward vertically near the disk portion 22 of the joystick 20, applying pressure inward and urging the joystick cap body 110 to engage snuggly with the top portion 22 of the joystick 20.

The cavity 118 may be contoured to tailor the tactile feedback of a user interacting with the joystick cover 101. As shown in FIG. 6, the cavity 118 of the joystick cap body 110 may also have a contoured inner surface 120 of the cavity 118. When the joystick cover 101 is attached to the joystick 20, a void 70 may form between the countered inner surface 120 and the top surface of the disk-shaped top portion of the joystick 20. The size of the void 70 may affect the overall elasticity of the joystick cover 101 and may be tailored to provide the user with a more cushioned tactile feedback.

FIG. 6 also illustrates the raised shoulder 160 on the retainer ring 150. The raised shoulder 160 around the joystick cover 101 provides gamers with a “thumb grip wall” and provides additional leverage to the existing joystick. Furthermore, the shoulder 160 prevents the user's thumbs from slipping off during intense gaming sessions. The larger thumb grip surface area provides gamers with more comfort and ease. This allows for longer gaming sessions. This feature may be helpful for users with larger hands who find it difficult to use the tiny, commercially available joysticks.

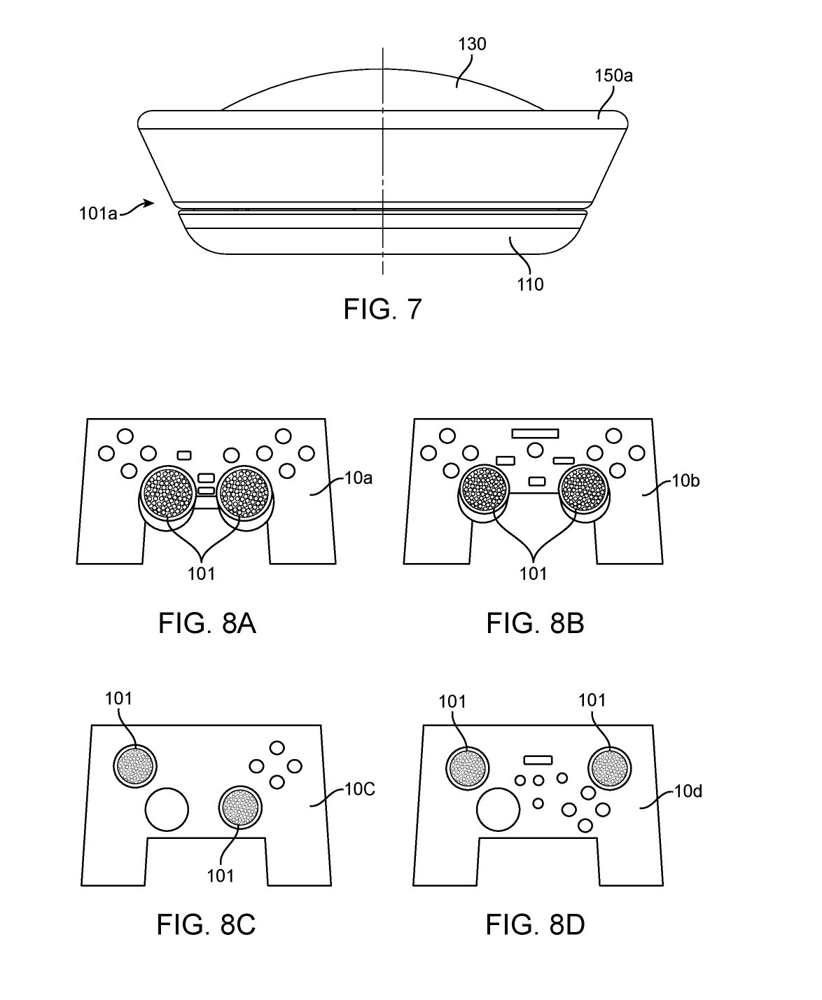

FIG. 7 is a side view of a joystick cover 101a in an embodiment. The joystick cover 101a comprises an elastomeric joystick cap body 110 (i.e., an elastomeric body 110), a disk-shaped cover 130, and a retainer ring 150a having similar properties as described above. However, retainer ring 150a does not have a raised shoulder 160 as seen in joystick cover 101 illustrated in FIG. 6 for example. Comparing retainer rings 150 and 150a illustrates that the user's tactile feedback may be tailored by altering the shape of the retainer rings 150 and 150a. Minor changes in the shape of the retainer rings 150/150a may provide differing user experiences, where users may select the joystick cover 101 and 101a which best suites the needs of the user.

FIGS. 8A-8D are top views of joystick covers 101 coupled to various game controllers 10a-10d. These figures illustrate that the joystick cover 101 provides for a universal joystick cover which may be used on different makes and models of gaming controllers.

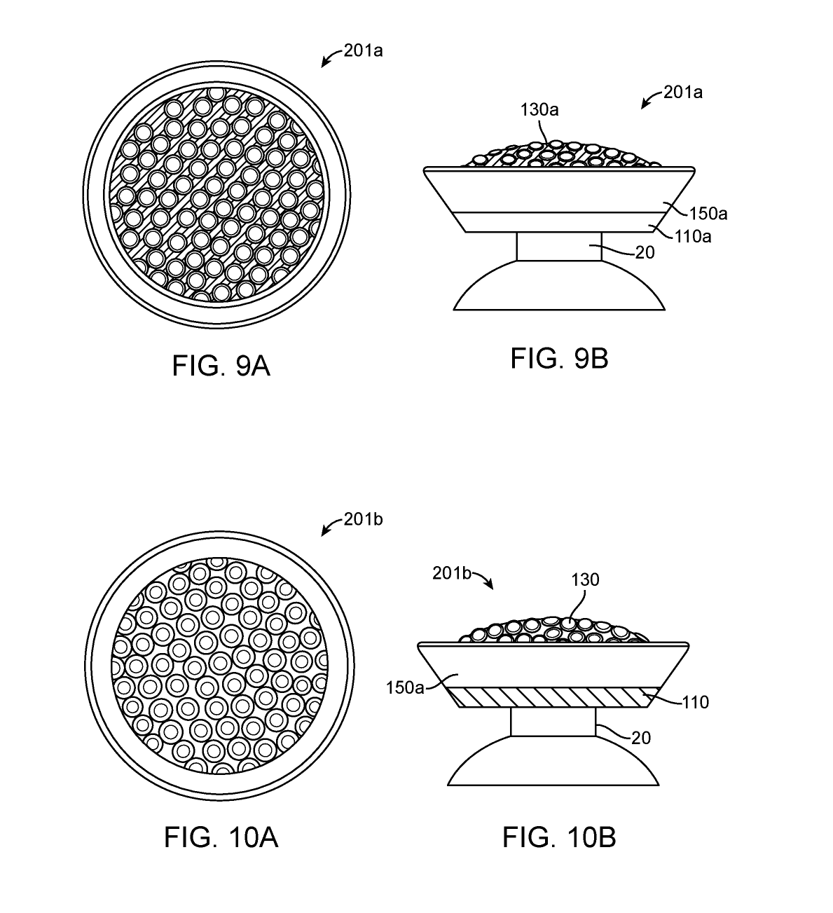

FIGS. 9A, 9B, 10A, and 10B illustrate that different combinations of joystick cap bodies 110 and 110a, covers 130 and 130a, and retainer rings 150 and 150a can be mixed and matched to provide a customized joystick appropriate to users' preferences, type of sport being played on the video game, and color scheme for a professional sports team for example. FIG. 9A is a top view of a joystick cover 201a having a cover 130a fabricated from the material used to manufacture footballs. FIG. 9B is a side view of a joystick cover 201a having a cover fabricated from the material used to manufacture footballs, where the joystick cover is attached to a joystick 20 of a game controller 10. In an embodiment, the color of retainer ring 150a matches that of joystick cap body 110a.

FIG. 10A is a top view of a joystick cover 201b having a cover 130 fabricated from the material used to manufacture basketballs. FIG. 10B is a side view of a joystick cover 201 b having a cover 130 fabricated from the material used to manufacture basketballs, where the joystick cover is attached to a joystick 20 of a game controller 10. In this embodiment, joystick cap body 110 may have a different color the retainer ring 150a as represented by the hash lines on the joystick cap body 110.

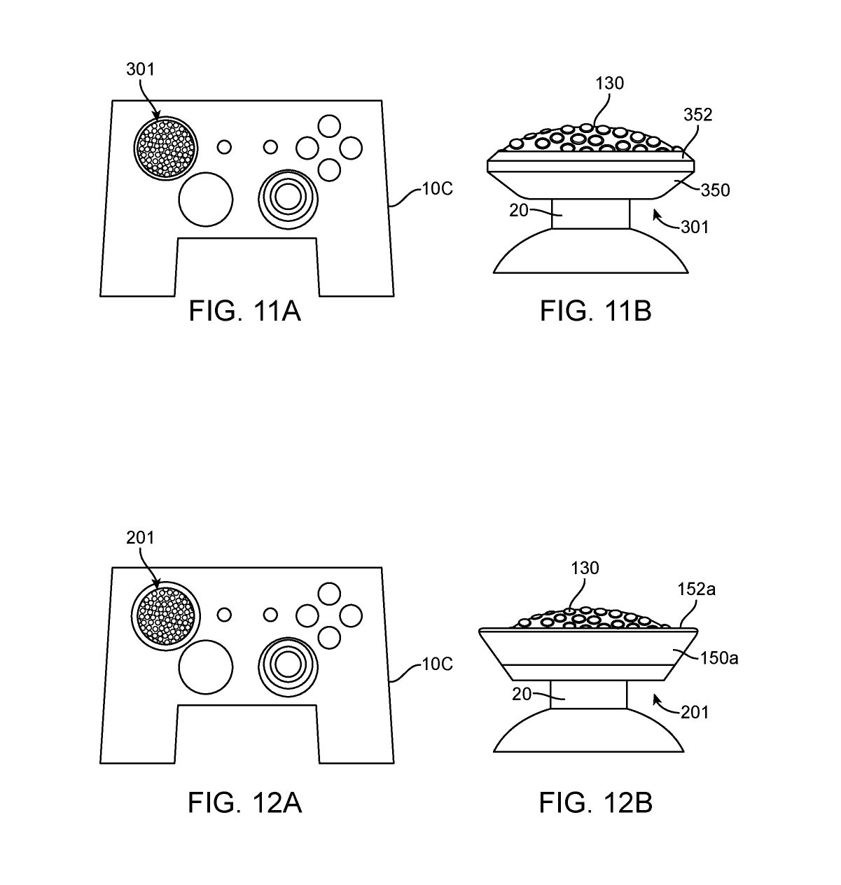

FIGS. 11A-13B further illustrate the ability to customize embodiments of the joystick covers 101, 201, 301, and 401 by selecting differing joystick cap bodies, covers, and retainer rings. FIG. 11A is a top view of a joystick cover 301 attached to a joystick 20 of a game controller 10c in an embodiment. FIG. 11B is a side view of a joystick cover 301 in an embodiment. Joystick cover 301 has a retainer ring 350 which has inward slopping bevel 352 which tends to provide a smoother tactile feel to the user.

FIG. 12A is a top view of a joystick cover 201 attached to a joystick 20 of a game controller 10c in an embodiment. FIG. 12B is a side view of a joystick cover 201 in an embodiment. Joystick cover 201 has a retainer ring 150a and a top surface 152a which is generally flat, which may enable the user to have an improved grip on the joystick cover 201 during use.

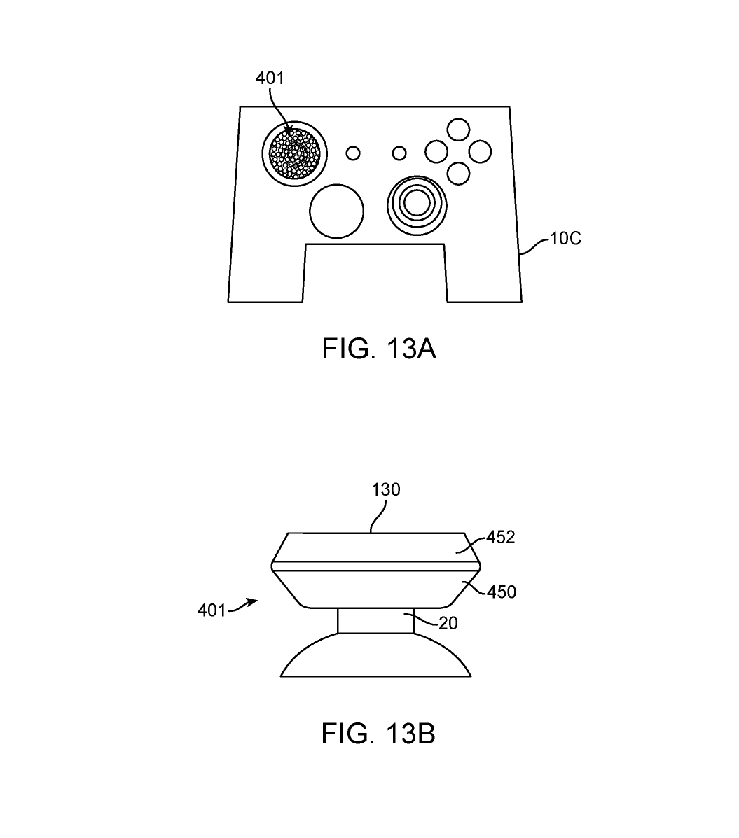

FIG. 13A is a top view of a joystick cover 401 attached to a joystick 20 of a game controller 10c in an embodiment. FIG. 13B is a side view of a joystick cover 401 in an embodiment. Joystick cover 401 has a retainer ring 450 which has inward slopping bevel 452 that extends more inward which tends to provide a smoother tactile feel to the user.

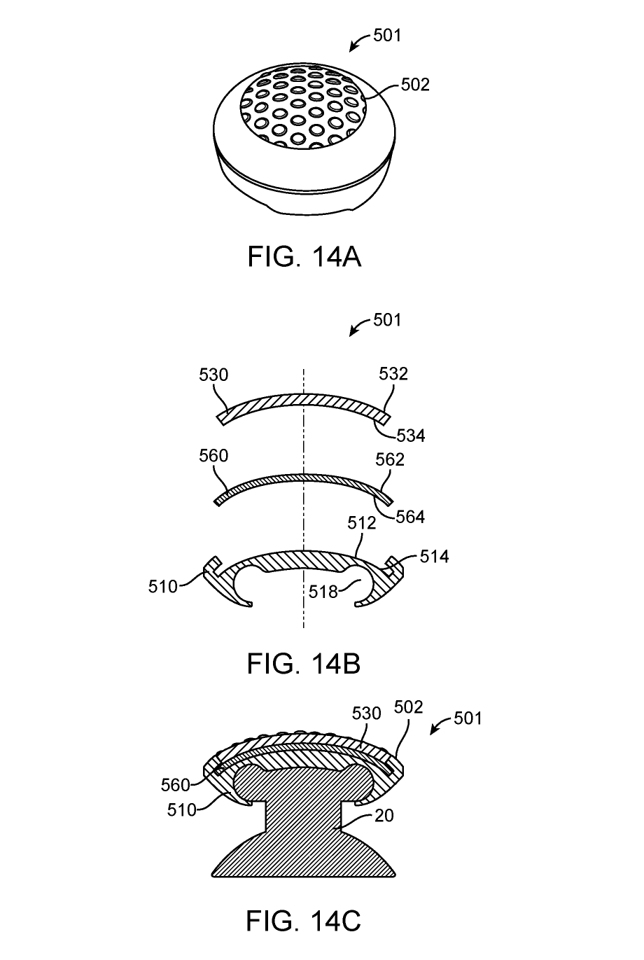

FIG. 14A is a side, perspective view of a joystick cover 501 in an embodiment. FIG. 14B is an exploded view of a joystick cover 501, and FIG. 14C is the cross-sectional view of the assembled joystick cover 501 on a joystick 20. The joystick cover 501 (i.e., cover attachment) comprises a joystick cap body 510 (i.e., an elastomeric body 510) having a top surface 512 and a cavity 518 formed for receiving a joystick controller 20, the cavity 518 formed on the bottom surface opposite the top surface 512. In one or more embodiments, the joystick cap body 510 is fabricated from natural or synthetic rubber.

The joystick cap body 510 has a channel 514 formed generally radially at the inner perimeter of the joystick cap body 510. The channel 514 is formed to receive and detachably secure the disk-shaped cover 530 and the second disk-shaped cover 560 described below. The top surface 512 of the joystick cap body 510 may have a convex contour which urges the cover 530 is similarly extend upward.

The joystick cover 501 has a generally disk-shaped cover 530 having a top surface 532 and a bottom surface 534. The cover 530 may be fabricated with material used to fabricate sporting equipment such as baseballs, basketball, footballs, or racing grips for example. The top surface 532 of the cover 530 may be texturized to replicate an item associated with an activity, or may have an imprinted image or text.

The joystick cover 501 further comprises an intermediary second disk-shaped cover 560 having a top surface 562 and a bottom surface 564. In an embodiment, the second disk-shaped 560 cover may be formed as a material plate and may be fabricated out of ABS plastic for example.

The top surface 562 of the second disk-shaped cover 560 is coupled to the bottom surface 534 of the disk-shaped cover 530, perhaps through the use of a glue or adhesive. The cover 530 and second disk-shaped cover 560 fit snuggly into the top surface 512 of the joystick cap body 510 with a pressure fit held in place with the channels 514. In one or more embodiments, a seamless edge 502 is formed between the joystick cap body 510 and the disk-shaped cover 530.

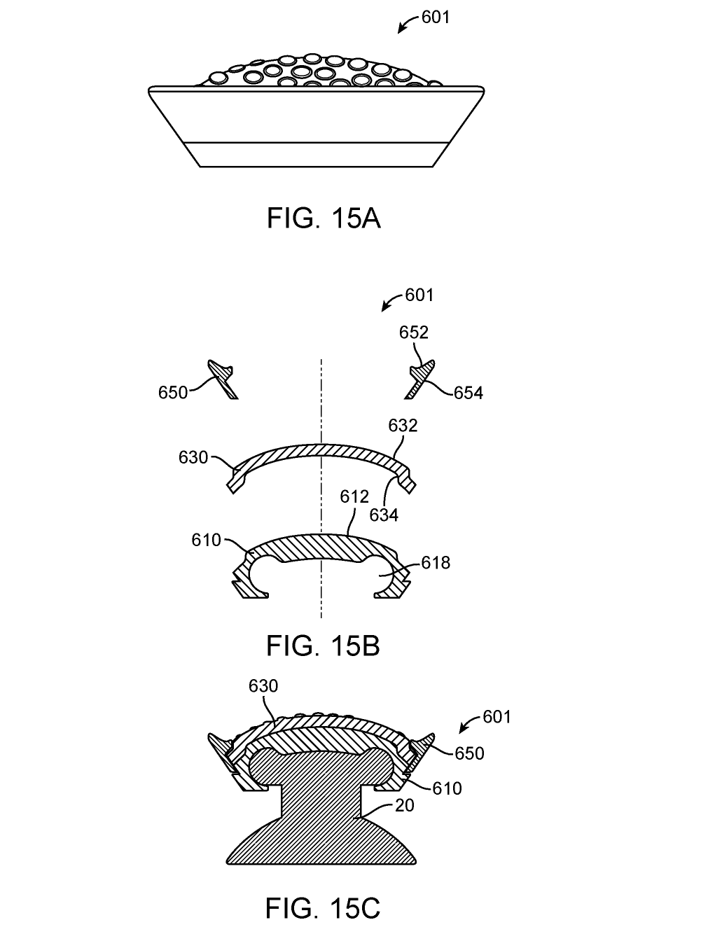

FIG. 15A is a side view of a joystick cover 601 in an embodiment. FIG. 15B is an exploded view of a joystick cover 601, and FIG. 15C is the cross-sectional view of the assembled joystick cover 501 on a joystick 20.

The joystick cover 601 (i.e., cover attachment) comprises and an elastomeric joystick cap body 610 (i.e., an elastomeric body 610) having a top surface 612 and a cavity 618 formed for receiving a joystick controller 20, the cavity 618 formed opposite the top surface 612. In an embodiment, the joystick cap body 610 may be fabricated out of natural or synthetic rubber. The top surface 612 of the joystick cap body 610 may have a convex contour which urges the cover 630 is similarly extend upward.

The joystick cover 601 has a disk-shaped cover 630 having a top surface 632 and a bottom surface 634. The bottom surface 634 of the cover 630 is coupled to the joystick cap body 610. The cover 630 may be fabricated with material used to fabricate sporting equipment such as baseballs, basketball, footballs, or racing grips for example. The top surface 632 of the cover 630 may be texturized to replicate an item associated with an activity, or may have an imprinted image or text.

The joystick cover 601 further comprises an annular outer ring 650 having a top surface 652 and generally cylindrical outer ring sidewalls 654 (i.e., retainer body). The outer ring sidewalls 654 are formed to detachably couple with the joystick cap body 610 which secures the cover 630 to the joystick cap body 610. In an embodiment, the retainer ring 650 may be fabricated out of ABS plastic for example.

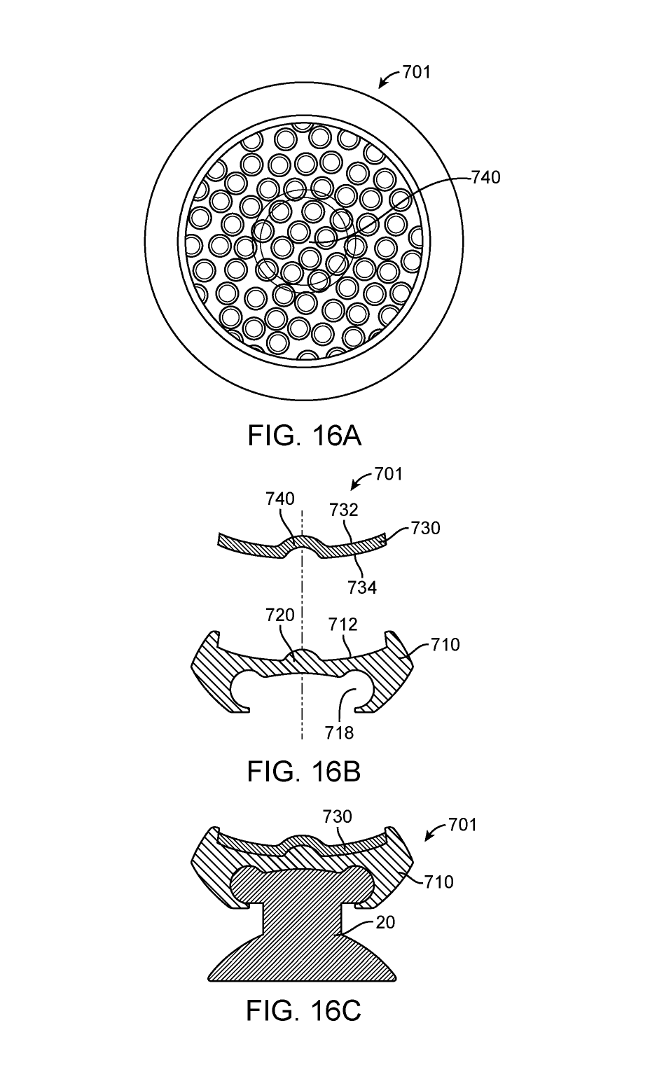

FIG. 16A is a top, perspective view of a joystick cover 701 having a convex contour with a center protrusion 740 in an embodiment. FIG. 16B is an exploded view of a joystick cover, and FIG. 16C is the cross-sectional view of the assembled joystick cover 701 on a joystick 20.

The joystick cover 701 (i.e., cover attachment) comprises an elastomeric joystick cap body 710 (i.e., an elastomeric body 710) having a top surface 712 and a cavity 718 formed for receiving a joystick controller 20, the cavity 718 formed opposite the top surface 712. In an embodiment, the joystick cap body 710 may be fabricated out of natural or synthetic rubber. The joystick cap body 710 further comprises a rounded protrusion 720 emerging away from the top surface 712 of the joystick cap body 710. The protrusion 720 is formed at the center of the joystick cap body 710. This protrusion 720 or “bump” in the center of the joystick cover 701 provides a “home location” to the user. The top surface 712 of the joystick cap body 710 may have a concave contour which urges the cover 730 is similarly extend downward.

The joystick cover 701 has a disk-shaped cover 730 having a top surface 732 and a bottom surface 734. The bottom surface 734 of the cover 730 is coupled to the joystick cap body 710. The cover 730 may be fabricated with materials used to fabricate sporting equipment such as baseballs, basketball, footballs, or racing grips for example. The top surface 732 of the cover 730 may be texturized to replicate an item associated with an activity, or may have an imprinted image or text. The cover 730 having a cover rounded protrusion 740 emerging away from the top surface 732 of the cover 730, the cover rounded protrusion 740 formed at the center of the cover 730. The cover 730 may attach to the joystick cap body with adhesives or glue in an embodiment.

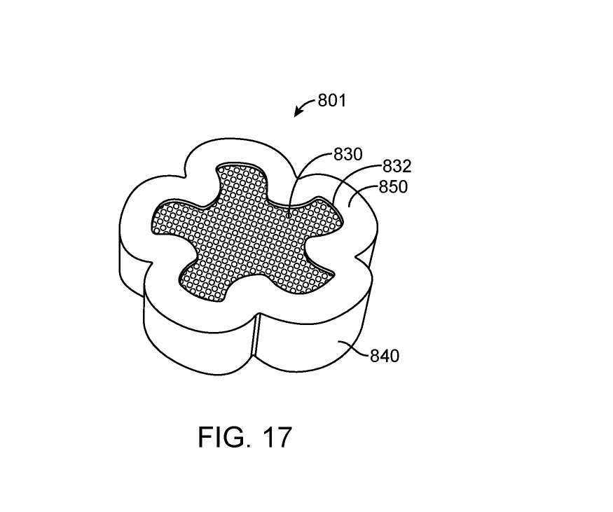

FIG. 17 is a top, perspective view of a joystick having an alternative shape in an embodiment. The joystick cover 801 (i.e., joystick attachment) comprises a cover 830 having a top surface, and a retainer body 850 coupled to a joystick, the retainer body 850 having sidewalls 840. The material of the cover 830 is captured by the retainer body 850. In one or more embodiments, the retainer body 850 and the cover 830 may be formed into various shapes including polygons, rounded polygons, and outlines of common physical objects or logos, for example. The cover 830 may be fabricated with material used to fabricate sporting equipment such as baseballs, basketball, footballs, or racing grips for example. The top surface 832 of the cover 830 may be texturized to replicate an item associated with an activity, or may have an imprinted image or text.

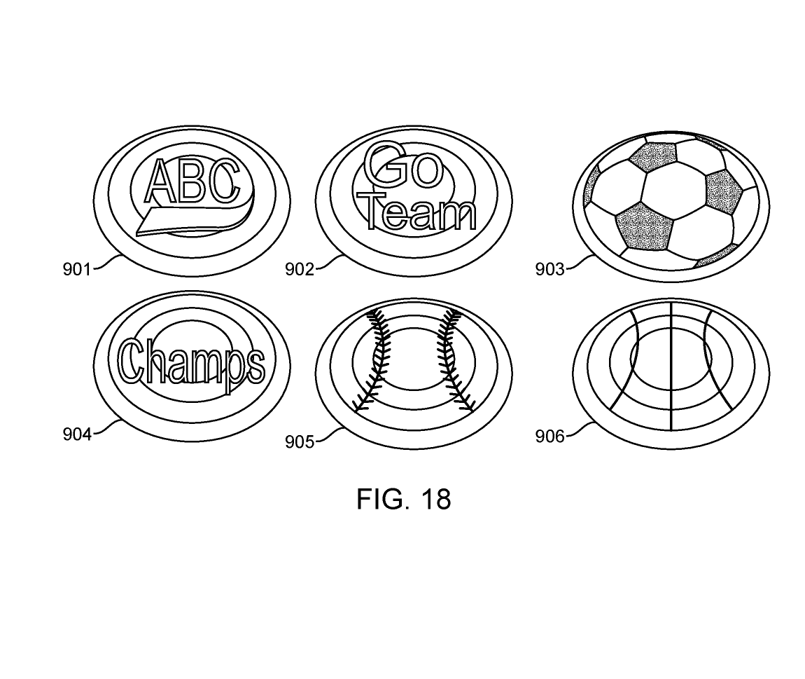

FIG. 18 depicts top views of covers having images of brand logos and sport accessories. Covers 901, 902, and 904 may comprise images or text including branding information such as trademarks or service marks. Covers 903, 905, and 906, may comprise images of objects such as sporting accessories such as baseballs, soccer balls, tennis balls, and other sporting equipment for example.

Although the invention has been discussed with reference to specific embodiments, it is apparent and should be understood that the concept can be otherwise embodied to achieve the advantages discussed. The preferred embodiments above have been described primarily as joystick covers for attaching to and covering joysticks for game controllers. In this regard, the foregoing description of the joystick covers is presented for purposes of illustration and description. It shall be understood that other combinations of covers, elastomeric bodies, rings, with differing sizes, shapes, colors, and materials are contemplated in one or more embodiments.

Furthermore, the description is not intended to limit the invention to the form disclosed herein. Accordingly, variants and modifications consistent with the following teachings, skill, and knowledge of the relevant art, are within the scope of the present invention. While embodiments depicted herein describe an elastomeric, joystick cap body for securing to the joystick, other mechanisms of joystick attachments bodies are contemplated in one or more embodiments including bodies that adhere to the joystick using an adhesive, bodies that attach to joysticks via a set-screw, bodies that attach to joystick using threads, for example.

The concepts discussed herein may be applied to other joystick devices or for applications including industrial controllers, interface devices, flight controllers, home consoles, and control pads for example. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

What is claimed is:

1. A cover attachment for a controller joystick, the attachment comprising:
an elastomeric body having a top surface and a cavity formed for receiving a joystick controller, the cavity formed on the bottom surface opposite the top surface; and,
a disk-shaped cover having a top surface and a bottom surface, the bottom of the disk-shaped cover coupled to top surface of the elastomeric body.

2. The cover attachment for a controller joystick of claim 1, wherein the top surface of the disk-shaped cover is texturized to replicate an item associated with an activity.

3. The cover attachment for a controller joystick of claim 1, wherein the top surface of the disk-shaped cover comprises an image or text.

4. The cover attachment for a controller joystick of claim 1, further comprising:
an retainer body having an aperture, a top surface, sidewalls, and a bottom surface, the sidewalls having at least one tab emerging inward from the bottom surface of the retainer body, the retainer body formed for detachably receiving the cover and elastomeric body;
wherein:
the elastomeric body further comprises generally cylindrical sidewalls having at least one slot, and
the slots of the elastomeric body are formed to receive the tabs of the retainer body.

5. The cover attachment for a controller joystick of claim 4, where the retainer body further comprises a raised shoulder emerging away from the top of the retainer body.

6. The cover attachment for a controller joystick of claim 1, further comprising an intermediary second disk-shaped cover having a top surface and a bottom surface, the top surface of the second disk-shaped cover coupled to the bottom surface of the disk-shaped cover, the bottom surface of the second disk-shaped cover coupled to the elastomeric body.

7. The cover attachment for a controller joystick of claim 6, wherein the elastomeric body has a channel formed generally radially at the inner perimeter of the elastomeric body, the channel formed to receive and detachably secure the disk-shaped cover and the second disk-shaped cover.

8. The cover attachment for a controller joystick of claim 7, wherein the second disk-shaped cover is fabricated from ABS plastic.

9. The cover attachment for a controller joystick of claim 1, further comprising an annular outer ring having a top surface, generally cylindrical outer ring sidewalls, the outer ring sidewalls formed to detachably couple with the elastomeric body securing the cover to the elastomeric body.

10. The cover attachment for a controller joystick of claim 1, wherein:
the elastomeric body further comprises a rounded protrusion emerging away from the top surface of the elastomeric body, the protrusion formed at the center of the elastomeric body;
the generally disk-shaped cover having a cover rounded protrusion emerging away from the top surface of the cover, the cover rounded protrusion formed at the center of the cover.

11. A cover attachment for a controller joystick, the attachment comprising:
an elastomeric body having a top surface, generally cylindrical sidewalls having at least one slot, and a cavity formed for receiving a controller joystick, the cavity formed opposite the top surface of the body;
a disk-shaped cover having a top surface and a bottom surface, the bottom surface of the disk-shaped cover positioned against the top surface of the elastomeric body;
an annular retainer ring having a top surface, generally cylindrical sidewalls, and a bottom surface, the retainer ring sidewalls having at least one tab emerging inward from the cylindrical sidewalls of the retainer ring, the retainer ring formed for detachably receiving the cover and elastomeric body;
wherein the slots of the elastomeric body are formed to receive the tabs of the retainer ring.

12. The cover attachment for a controller joystick of claim 11, wherein the disk-shaped cover is fabricated out of a material associated with an activity.

13. The cover attachment for a controller joystick of claim 11, wherein the top surface of the disk-shaped cover is texturized to replicate an item associated with an activity.

14. The cover attachment for a controller joystick of claim 11, wherein the top surface of the cover comprises an image or text.

15. The cover attachment for a controller joystick of claim 11, where the retainer ring further comprises a raised shoulder emerging away from the top of the retainer ring.

16. The cover attachment for a controller joystick of claim 11, wherein the elastomeric body, the disk-shaped cover, and the retainer ring each have a color, wherein the colors of each are selected to match a color scheme.

17. The cover attachment for a controller joystick of claim 11, wherein the disk-shaped cover is fabricated from ABS plastic.

18. A cover attachment for a controller joystick, the attachment comprising:
a joystick attachment body having a top surface, sidewalls, and a coupling mechanism for detachably securing a joystick controller;
a cover having a top surface and a bottom surface, the bottom surface positioned against the top surface of the joystick attachment body; and,
a retainer body having a top surface, sidewalls, and a bottom surface, the sidewalls formed to detachably couple with the joystick attachment body.

19. The cover attachment for a controller joystick of claim 18, wherein the top surface of the cover is texturized to replicate an item associated with an activity.

20. The cover attachment for a controller joystick of claim 18, wherein the top surface of the cover comprises an image or text.
